(19) United States
(12) Patent Application Publication
(10) Pub. No.: US 2018/0154535 A1
(43) Pub. Date: Jun. 7, 2018

(54) CUTTING DEVICE AND PRINTING APPARATUS

(71) Applicant: SEIKO EPSON CORPORATION, Tokyo (JP)

(72) Inventors: Naoto HAYAKAWA, Shiojiri (JP); Naohiro UEYAMA, Matsumoto (JP)

(21) Appl. No.: 15/823,258

(22) Filed: Nov. 27, 2017

(30) Foreign Application Priority Data
Dec. 1, 2016 (JP) 2016-233917

(51) Int. Cl. B26D 1/143; B41J 11/70; B26D 1/08; B26D 1/00

(52) U.S. Cl. CPC B26D 1/143; B41J 11/706; B26D 1/085; B26D 2001/002; B41J 11/703; B26D 2001/0053; B26D 1/0006

(57) ABSTRACT

A cutting device includes a circular driving blade that rotates and drives, a circular driven blade that is driven to rotate accompanying rotation of the driving blade, and a holding portion that rotatably holds the driving blade and the driven blade in a state of cutting edges thereof being aligned with each other, wherein a tapered surface that becomes tapered from a second cutting edge side toward a second revolving shaft side of the driven blade is formed on the second contact surface on the side that contacts the driving blade in the driven blade.

### BACKGROUND

### 1. Technical Field

The present invention relates to a cutting device that cuts a medium and a printing apparatus that is provided with the cutting device.

### 2. Related Art

A printer that performs printing on a transported medium is known as an example of a printing apparatus from the related art. A cutting device that cuts a medium on which printing is performed to a desired size is provided in such a printer.

For example, the sheet material cutting device described in JP-A-2006-305662 cuts a sheet material by a carriage (holding portion) that rotatably holds a pair of round blades (driving blade and driven blade) moving back and forth in a width direction that intersects with a transport direction of the sheet material (medium).

Note that, in a case where a sheet material with an adhesive is cut, a cut surface of a cut sheet material and a counterpart blade contact surface of a round blade may contact, and an adhesive residue may adhere to the counterpart blade contact surface. Therefore, the sheet material cutting device in JP-A-2006-305662 is provided with an adhesive residue discharge hole in the round blade and therefore the adhesive residue that adheres to the counterpart blade contact surface is discharged to the opposite side. However, in a case where the adhesive residue adheres to the shaft of the round blade (revolving shaft) and the like, there is a concern that the adhesive residue hinders rotation of the round blade and cutting precision of the sheet material is reduced.

Note that, such a problem is not limited to a printer that is provided with a sheet material cutting device, and is generally common in a printing apparatus which is provided with a cutting device.

### SUMMARY

An advantage of some aspects of the invention is to provide a cutting device that is able to suppress a reduction of cutting precision when cutting a medium and a printing apparatus that is provided with the cutting device.

Hereinafter, means of the invention and operation effects thereof will be described.

According to an aspect of the invention, there is provided a cutting device including a circular driving blade that rotates and drives, a circular driven blade that is driven to rotate accompanying rotation of the driving blade, and a holding portion that rotatably holds the driving blade and the driven blade in a state of the cutting edges thereof being aligned with each other, wherein a tapered surface that becomes tapered from the cutting edge side toward the revolving shaft side of the driven blade is formed on the contact surface on the side that contacts the driving blade in the driven blade.

In a case where a medium with an adhesive is cut, an adhesive tends to adhere to the driven blade that is driven and rotates in comparison to the driving blade that rotates and drives. In addition, in a case where the medium is cut by the driven blade that does not form a tapered surface, the entire cut surface of the cut medium is in sliding contact with the contact surface of the driven blade and the adhesive adheres to the driven blade. In this point, according to this configuration, it is possible to reduce a contact area of the cut surface of the cut medium and the driven blade to form a tapered surface on the contact surface of the driven blade. Accordingly, it is possible to suppress adhesion of the adhesive to the driven blade, and reduce the cutting precision when cutting the medium.

In the cutting device, preferably the driven blade is formed with the cover portion having the tapered surface installed on a blade body that has the cutting edge.

According to this configuration, it is possible to separate the tapered surface and the cutting edge by installing the cover portion on the blade body. Accordingly, in comparison to a case where the cutting edge and the tapered surface are integrally manufactured, it is possible to easily manufacture the driven blade.

In the cutting device, preferably the cover portion is formed of a material that it is more difficult for adhesive to adhere to than the blade body.

According to this configuration, it is possible to further suppress adhesion of the adhesive in order to form the cover portion of a material that it is difficult for adhesive to adhere to.

Preferably, the cutting device is further provided with a medium guiding portion that guides toward the revolving shaft side of the driven blade a medium cut in the cutting device, in which the cutting edges of the driving blade and the driven blade are aligned with each other, and that cuts the medium.

According to this configuration, it is possible to guide the medium to the tapered surface side that is formed between the cutting edge of the driven blade and the revolving shaft by providing the medium guiding portion that guides the cut medium. Therefore, it is possible to reduce a concern that the cut surface of the medium contacts a different location from the tapered surface and adhesive adheres.

According to another aspect of the invention, there is provided a printing apparatus including a cutting device with the above-described configuration, a transport unit that transports a medium from an upstream side to a downstream side in a transport direction of the medium, and a printing portion that prints on the medium.

According to this configuration, the printing apparatus exhibits the same effects as the cutting device.

### BRIEF DESCRIPTION OF THE DRAWINGS

The invention will be described with reference to the accompanying drawings, wherein like numbers reference like elements.

FIG. 1 is a schematic diagram illustrating an internal structure of an embodiment of a printing apparatus provided with a cutting device.

FIG. 2 is a perspective view of the cutting device in which a cutting mechanism is positioned at a standby position.

FIG. 3 is a front view of the cutting mechanism.

FIG. 4 is a side view of a driving blade and a driven blade viewed from the tip side in a cutting direction.

FIG. 5 is a side view of the driving blade and the driven blade viewed from the rear side in the cutting direction.

FIG. 6 is a side view of the driving blade and the driven blade that cut the medium.

FIG. 7 is a side view of the driving blade and the driven blade of a comparative example.

### DESCRIPTION OF EXEMPLARY EMBODIMENTS

An embodiment of a printing apparatus provided with a cutting device will be described below with reference to the drawings. Note that, the printing apparatus of the present embodiment is an ink jet printer that performs printing (recording) by ejecting ink, which is an example of liquid, on a medium such as a paper sheet.

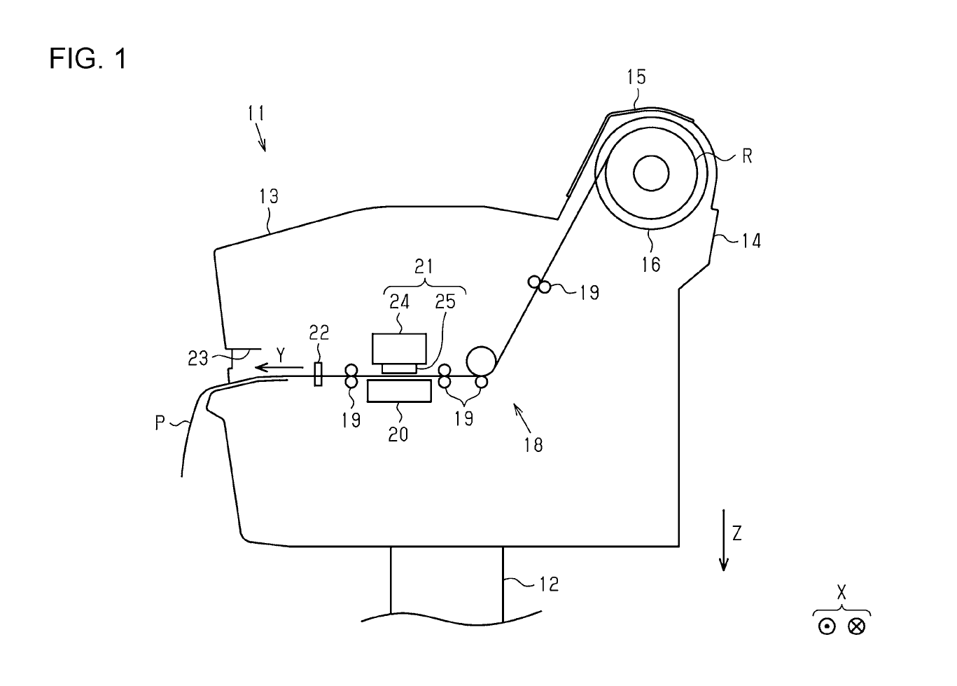

As shown in FIG. 1, the printing apparatus 11 is provided with a casing 13 with an approximate rectangular cube shape supported on a leg base 12 and a feeding portion 14 that is installed on the rear surface side of the casing 13. The feeding portion 14 is provided with a feeding cover 15 that is provided to be able to open and close. Then, a roll R in which a medium P such as paper sheets is rolled up in a cylindrical shape is loaded on the feeding portion 14. The roll R that is loaded on the feeding portion 14 is rotatably held by a holding unit 16 that is provided on both sides in a width direction X.

The printing apparatus 11 is provided with a transport unit 18 that transports the medium P that is fed from a feeding portion 14 from the upstream side to the downstream side in a transport direction Y. The transport unit 18 of the embodiment transports the medium P by rotating a transport roller 19 of at least one pair (four pairs in the embodiment) in a state of holding the medium P.

Furthermore, the printing apparatus 11 is provided with a support base 20 that supports the transported medium P, a printing portion 21 that prints a character, an image, or the like on the medium P that is supported on the support base 20, and a cutting device 22 that cuts the printed medium P. Then, a discharge port 23 is open to the front surface of the casing 13 in order to discharge the printed and cut medium P outside of the casing 13.

The printing portion 21 is provided with a carriage 24 that is able to move back and forth along the width direction (scanning direction) X, and a discharge head 25 that is installed in the carriage 24 and discharges ink on the medium P. That is, the printing portion 21 performs printing on the medium P by discharging ink while moving in the width direction X. Note that, the width direction X in the embodiment is a direction that intersects with (preferably orthogonal to) a transport direction Y and a direction of gravity Z of the medium P, and is a direction that matches the longitudinal direction of the casing 13 and the feeding portion 14.

Next, the cutting device 22 will be described.

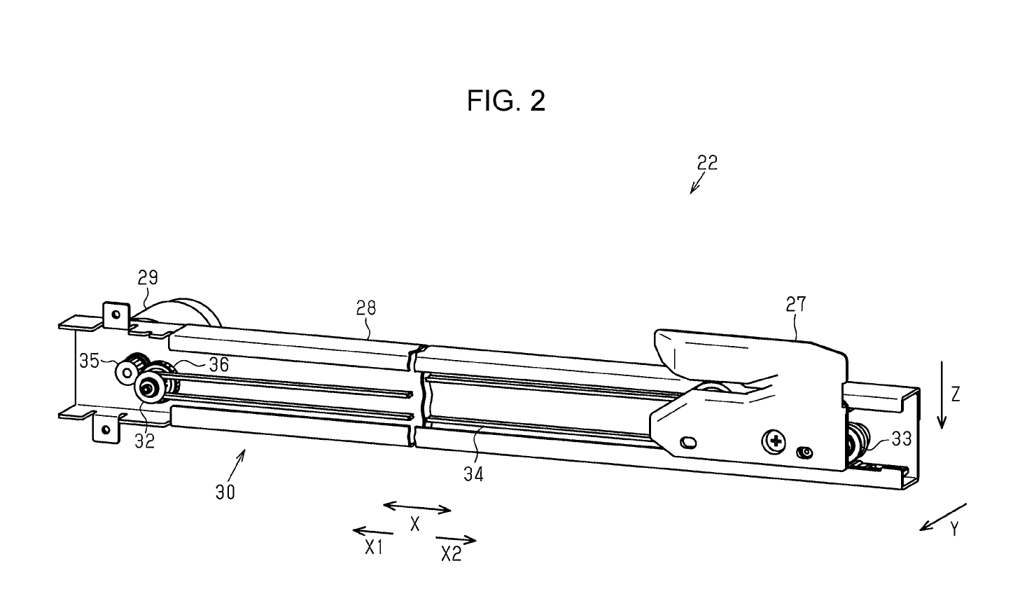

As shown in FIG. 2, the cutting device 22 is provided with a cutting mechanism 27 that is able to cut the medium P and a guide rail 28 that is provided so as to extend along the width direction X. In the guide rail 28, a driving source 29 such as an electric motor is provided on one end (left end in FIG. 2) side in the width direction X. Furthermore, the cutting device 22 is provided with a movement mechanism 30 that communicates motive force of the driving source 29 to the cutting mechanism 27 and moves back and forth the cutting mechanism 27 along the width direction X. Then, in the embodiment, the position on another end (right end) side in the width direction X indicated in FIG. 2 is set as a standby position of the cutting mechanism 27 and the one end side position in the width direction X is a non-standby position. Note that, the cutting mechanism 27 and the movement mechanism 30 are installed on a surface facing the downstream side in the transport direction Y in the guide rail 28, and the driving source 29 is installed on the surface facing the upstream side in the transport direction Y.

The movement mechanism 30 is provided with driving pulley 32 that is provided on one end side of the guide rail 28, and a driven pulley 33 that is provided on the other end side of the guide rail 28, and an annular belt 34 that is wound around the driving pulley 32 and the driven pulley 33. Furthermore, transmission gears 35 and 36 that transmit motive force of the driving source 29 are installed so as to mesh with each other on the output shaft of the driving source 29 and the shaft of the driving pulley 32. Then, the cutting mechanism 27 is linked to the belt 34 via a linking member which is not shown in the drawings.

Therefore, when the driving source 29 is driven, the movement mechanism 30 moves back and forth the cutting mechanism 27 along the width direction X. Specifically, when the driving source 29 is driven forward, the movement mechanism 30 is moved in a cutting direction X1 in which the cutting mechanism 27 faces from the standby position to the non-standby position. In addition, when the driving source 29 is driven forward, the movement mechanism 30 moves the cutting mechanism 27 in a return direction X2 from the non-standby position toward the standby position. Note that, the cutting direction X1 is a direction in which it is possible to cut the medium P.

Next, the cutting mechanism 27 will be described.

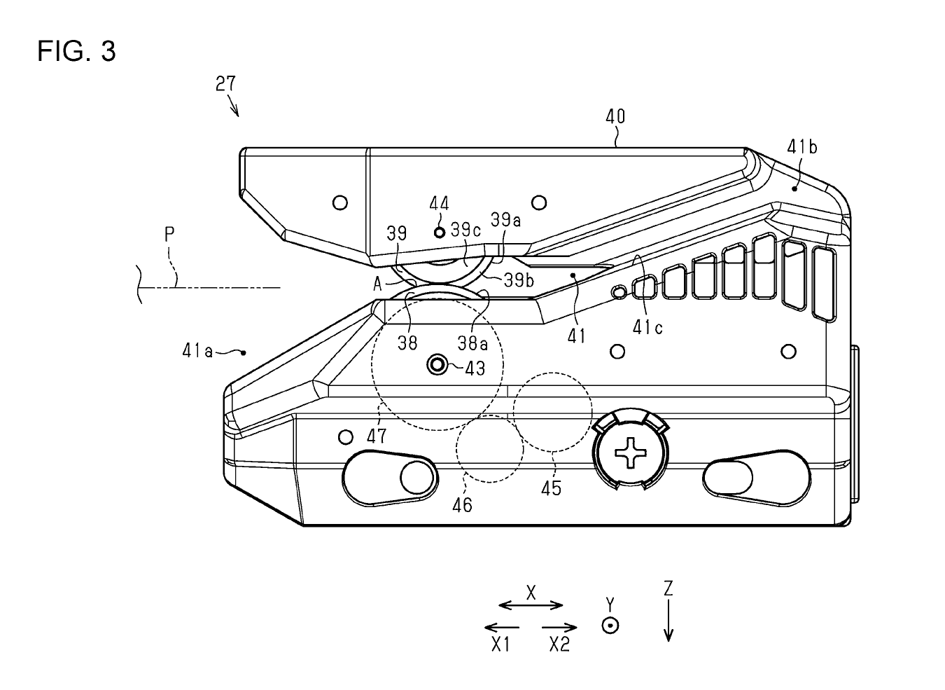

As shown in FIG. 3, the cutting mechanism 27 is provided with a circular driving blade 38 that drives to rotate, a circular driven blade 39 that is driven to rotate accompanying rotation of the driving blade 38, and a holding portion 40 that holds the driving blade 38 and the driven blade 39. Then, a medium passage 41 is provided across the width direction X in the holding portion 40. Note that, the medium passage 41 is a passage through which the medium P passes in a case where the cutting mechanism 27 moves in the cutting direction X1.

The holding portion 40 rotatably holds the driving blade 38 and the driven blade 39 in a state in which the cutting edges 38a and 39a thereof are aligned with each other. Then, in the embodiment, the position at which the cutting edges 38a and 39a of the driving blade 38 and the driven blade 39 are aligned with each other and the medium P is cut is set as cutting position A. The driving blade 38 and the driven blade 39 are provided in the direction of gravity Z, and the driving blade 38 is disposed further on the downstream side in the transport direction Y than the driven blade 39.

In the medium passage 41, the tip end in the cutting direction X1 is an inlet 41a, and the rear end in the cutting direction X1 is an outlet 41b. The inlet 41a is an opening into which the medium P is introduced to the medium passage 41 accompanying movement of the cutting mechanism 27 in the cutting direction X1, and is formed such that opening in the direction of gravity Z becomes larger toward the tip side in the cutting direction X1. In addition, the outlet 41b is an opening in which the cut medium P is lead out accompanying movement by the cutting mechanism 27 in the cutting direction X1.

Furthermore, a medium guiding portion 41c that extends to be inclined to an upper side from the cutting position A side toward the outlet 41b side is formed on the medium passage 41. Therefore, when the cutting mechanism 27 moves in the cutting direction X1 and cuts the medium P, the medium P that is cut at the cutting position A is guided to the upper side by the medium guiding portion 41c.

The driving blade 38 and the driven blade 39 are each rotatably supported by a first revolving shaft 43 and a second revolving shaft 44 that are provided so as to interpose the medium passage 41 in the direction of gravity Z. Specifically, the driven blade 39 is positioned above the driving blade 38, and at least one of the driving blade 38 and the driven blade 39 that are positioned at the cutting position A are provided so as to be exposed to the medium passage 41.

The cutting mechanism 27 is provided with a first gear 45 that rotates accompanying movement of the belt 34 (refer to FIG. 2) and a second gear 46 that rotates meshing with the first gear 45. Furthermore, a driving gear 47 that is able to rotate integrally with the driving blade 38 is supported on the first revolving shaft 43 that supports the driving blade 38 so as to rotate meshed with the second gear 46. Accordingly, when the driving source 29 drives and the cutting mechanism 27 moves, the driving blade 38 rotates and drives.

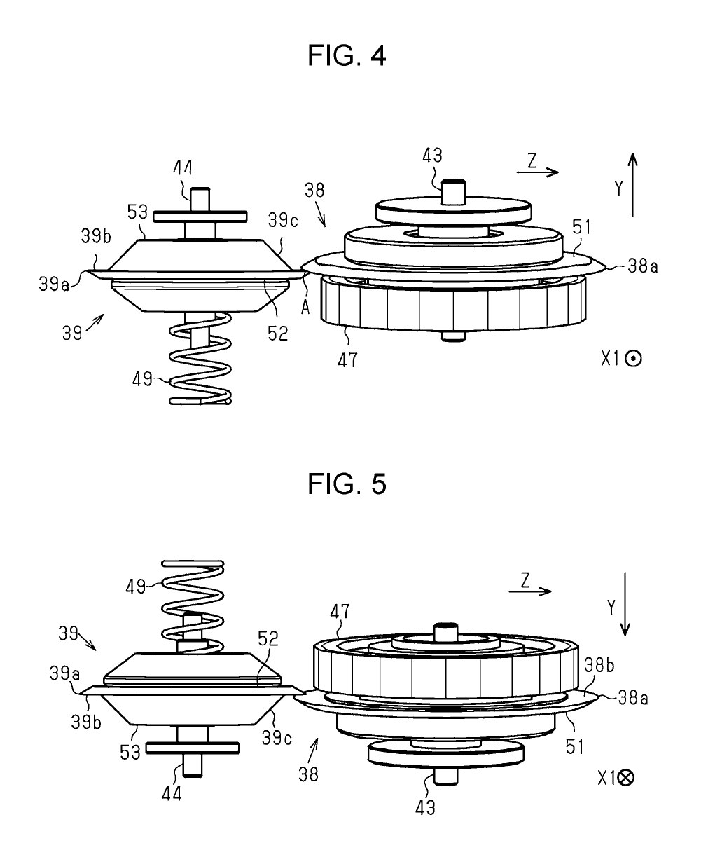

As shown in FIG. 4, the cutting mechanism 27 is provided with a biasing member 49 such as a spring that biases the driven blade 39 to the driving blade 38 side. Therefore, when the driving blade 38 rotates and drives, the driven blade 39 rotates together with the driving blade 38. Specifically, when the cutting mechanism 27 moves in the cutting direction X1, the driving blade 38 rotates in the clockwise direction and the driven blade 39 is driven and rotates in a counter clockwise direction viewed from the downstream side (front surface side) in the transport direction Y.

Next, the driving blade 38 and the driven blade 39 will be described.

As shown in FIGS. 4 and 5, the first revolving shaft 43 and the second revolving shaft 44 are positioned to twist non-parallel, and the driving blade 38 is provided inclined to the driven blade 39. That is, the driving blade 38 is provided such that a first cutting edge 38a intersects with the cutting direction X1. In addition, the driven blade 39 is provided such that a second cutting edge 39a is along the cutting direction X1. Specifically, the driving blade 38 and the driven blade 39 are provided such that the cutting edges 38a and 39a are aligned with each other at the tip side in the cutting direction X1 and are separated from each other toward the rear side in the cutting direction X1.

The driving blade 38 is provided with an approximately disc-shaped first blade body 51 and the driven blade 39 is provided with a second blade body 52 with a smaller diameter than the first blade body 51. Then, the cutting edges 38a and 39a are formed in a round shape on the periphery of the respective blade bodies 51 and 52. In addition, the cutting edges 38a and 39a are formed to have gradients so as to be tapered toward the outside in the radial direction of the blade bodies 51 and 52. Note that, the driving blade 38 and the driven blade 39 of the embodiment are formed in a so-called single-edged blade in which only the surface on the side opposite from a first contact surface 38b and a second contact surface 39b on a side that contacts with an overlap with a counterpart blade have a gradient.

A tapered surface 39c that becomes tapered from the second cutting edge 39a side toward a second revolving shaft 44 side of the driven blade 39 is formed on the second contact surface 39b on the side that contacts the driving blade 38 in the driven blade 39. The tapered surface 39c is formed so as to be separated from the second cutting edge 39a in the axial direction (transport direction Y) of the second revolving shaft 44 from the second cutting edge 39a toward the second revolving shaft 44 in the radial direction. In other words, the tapered surface 39c is configured by a partial surface of the conical surface passing through the axial center of the second revolving shaft 44 on the second blade body 52 side. In this arrangement, the tapered surface 39c may be a surface that is able to reduce a contact area between the cut surface of the medium P and the driven blade 39, and includes surfaces that are not narrow when viewed locally.

The driven blade 39 of the embodiment forms an approximate truncated cone shape cover portion 53 that has a tapered surface 39c installed on the second blade body 52 that has a second cutting edge 39a. The cover portion 53 is formed of a material that it is more difficult for adhesive to adhere to than the second blade body 52. For example, the second blade body 52 is formed by metal such as a high speed steel or stainless steel with higher intensity than the cover portion 53, and the cover portion 53 is formed by resin such as polyacetal resin (POM), fluororesin, or silicone resin.

Next, actions of the printing apparatus 11 that is constituted as described above and in particular, actions when the cutting device 22 cuts the medium P will be described.

As shown in FIGS. 2 and 3, when the cutting device 22 cuts the medium P, first, the cutting mechanism 27 that is positioned at the standby position moves in the cutting direction X1. At this time, the medium P is introduced to the medium passage 41 from the inlet 41a with the end on the standby position side (right side) as the top. Then, an incision is made on the medium P that is introduced to the medium passage 41 from the side end on one side (right side) in the width direction X by the rotating driving blade 38 and the driven blade 39, and the incision is cut across the width direction X up to the side end on the other side (left side).

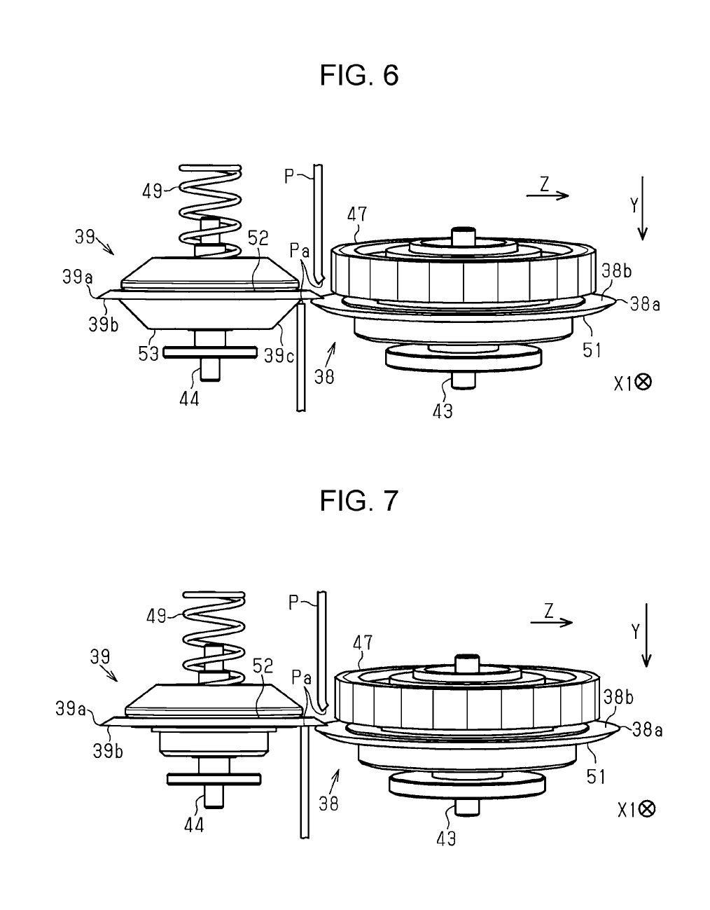

As shown in FIG. 6, the driving blade 38 of the embodiment is disposed with a posture inclined to the cutting direction X1. Therefore, out of the cut medium P, the possibility is low that a cut surface Pa on the upstream side in the transport direction Y and the driving blade 38 contact.

FIG. 7 illustrates a driven blade 39 that is not provided with a tapered surface 39c as a comparative example. In a case where, for example, the medium P that has an adhesive is cut by such a driven blade 39 such that paper is released, the cut surface Pa of the medium P and the second contact surface 39b of the driven blade 39 may contact and adhesive may adhere to the second contact surface 39b. Then, when adhesive adheres to the second contact surface 39b in such a manner, there is a concern that waste (for example, paper powder) of the medium P, dust in the air, or the like is further adhered to the adhesive and accumulate thickly, and there is an influence on rotary operation of the driving blade 38 and the driven blade 39.

Meanwhile, as shown in FIGS. 3 and 6, in the embodiment, the medium P that is cut at the cutting position A is guided toward the second revolving shaft 44 side (upper side) by the medium guiding portion 41c. Then, in the driven blade 39, the cut surface Pa of the medium P which is cut passes through the medium passage 41 in a state in which the contact area of the tapered surface 39c is reduced since the tapered surface 39c is formed between the second cutting edge 39a and the second revolving shaft 44.

Then, when the cutting mechanism 27 moves up to a non-standby position and cutting of the medium P by the cutting mechanism 27 is completed, subsequently, the cutting mechanism 27 moves in the return direction X2. In this manner, the medium P on which printing is performed by the printing portion 21 is cut by the cutting device 22 that is provided further on the downstream side than the printing portion 21 in the transport direction Y, and the cut medium P, which is a single slip of paper, is discharged from the discharge port 23 to outside of the casing 13.

According to the embodiment, it is possible to obtain the effects as above.

(1) In a case where the medium P with an adhesive is cut, an adhesive tends to adhere to the driven blade 39 that is driven and rotates in comparison to the driving blade 38 that rotates and drives. In addition, in a case where the medium P is cut by the driven blade 39 that does not form the tapered surface 39c, the entire cut surface Pa of the cut medium P that is in sliding contact with the second contact surface 39b of the driven blade 39 and the adhesive adheres to the driven blade 39. In this point, it is possible to reduce a contact area of the cut surface of the cut medium P and the driven blade 39 to form a tapered surface 39c on the second contact surface 39b of the driven blade 39. Accordingly, it is possible to suppress adhesion of the adhesive to the driven blade 39, and reduce the cutting precision when cutting the medium.

(2) It is possible to separate the tapered surface 39c and the second cutting edge 39a by installing the cover portion 53 on the second blade body 52. Accordingly, in comparison to a case where the second cutting edge 39a and the tapered surface 39c are integrally manufactured, it is possible to easily manufacture the driven blade 39.

(3) It is possible to further suppress adhesion of the adhesive in order to form the cover portion 53 of a material that it is difficult for adhesive to adhere to.

(4) It is possible to guide the medium P to the tapered surface 39c side that is formed between the second cutting edge 39a of the driven blade 39 and the second revolving shaft 44 by providing the medium guiding portion 41c that guides the cut medium P. Therefore, it is possible to reduce a concern that the cut surface Pa of the medium P contacts a different location from the tapered surface 39c and adhesive adheres.

(5) It is possible to easily cut the medium P in comparison to a case where the driving blade 38 and the driven blade 39 are provided to be aligned since one of the driving blade 38 and the driven blade 39 is provided inclined at a predetermined angle to the other blade.

(6) It is possible to easily cut the medium P along the cutting direction X1 by providing the driven blade 39 along the cutting direction X1. Furthermore, the cutting position A at which that first cutting edge 38a of the driving blade 38 and the second cutting edge of the driven blade 39 are aligned is positioned on the tip end in the cutting direction X1, and the driving blade 38 is provided so as to separate from the driven blade 39 toward the rear side in the cutting direction X1, therefore it is possible to reduce a concern that the cut surface Pa of the cut medium P contacts the driving blade 38.

(7) For example, in a case where the entire driven blade 39 is formed of a material to which adhesive tends not to adhere, it is difficult to obtain sufficient intensity of the second cutting edge 39a. In addition, in a case where the driven blade 39 is coated with a material to which adhesive tends not to adhere, there is a concern that adhered adhesive enters between the driving blade 38 and the driven blade 39 and cutting performance is reduced. In this point, since a cover portion 53 is formed of a material to which adhesive tends not to adhere, it is possible to suppress adhesion of the adhesive and suppress reduction of cutting performance while maintaining the intensity of the second cutting edge 39a.

(8) Even in a case where adhesive adheres to the cover portion 53 in order to form the cover portion 53 of a material that it is difficult for adhesive to adhere to, it is possible to shake off adhesive that adheres by centrifugal force accompanying rotation of the driven blade 39. Furthermore, it is possible to easily manufacture the driven blade 39 in comparison to a case where the second blade body 52 is coated with a material to which adhesive tends not to adhere.

Note that, the embodiment may be modified as in the modification example shown below. In addition, the embodiments and modified examples may be arbitrarily combined.
The cutting device 22 may be provided further on the upstream side in the transport direction Y than the printing portion 21. That is, the printing apparatus 11 may print on the medium P that is cut in the cutting device 22.
It is possible to arbitrarily modify the movement mechanism 30 if the cutting mechanism 27 is moved. For example, the movement mechanism 30 may be a worm gear that is configured by a screw gear that is provided across the width direction X and a helical gear that is provided in the cutting mechanism 27.
The form of the cover portion 53 may be arbitrarily modified if the form becomes tapered from the second cutting edge 39a toward the second revolving shaft 44. For example, the cover portion 53 may have a hemispherical shape, a semi-ellipsoidal shape, a half torus shape in which the second revolving shaft 44 side of a hemisphere or a semi-ellipsoid is depressed, a conical shape, or the like. In addition, the tapered surface 39c may be a side surface of the cover portion 53 of these forms, and may be a curved surface including an arcuate surface that is a side surface of a hemispherical cover portion or an elliptic arc surface that is a side surface of a semi-ellipsoidal cover portion. Furthermore, the curved surface may be a curved surface that swells to the outside in the manner of the arcuate surface and the elliptic arc surface, and may be a curved surface that is recessed to the inside.
It is possible for the cover portion 53 to be installed with the second blade body 52 by an arbitrary method. For example, the cover portion 53 may be installed by caulking to the second blade body 52, and may be adhered to the second blade body 52. In addition, the second blade body 52 and the second revolving shaft 44 may be provided to be integrally rotatable, and the cover portion 53 may be fixed to the second revolving shaft 44.
The driving blade 38 may be provided further on the upper side than the medium passage 41, and the driven blade 39 may be provided further on the lower side than the medium passage 41.
The driven blade 39 may be provided further on the downstream side in the transport direction Y than the driving blade 38.
The driving blade 38 may be provided across the cutting direction X1, and the driven blade 39 may be provided inclined to the driving blade 38. In addition, the driving blade 38 and the driven blade 39 may be provided to be aligned.
The cover portion 53 may also be provided in the driving blade 38. In addition, the tapered surface 39c may be formed in the driving blade 38.
The cutting device 22 may be configured without being provided with the medium guiding portion 41c. For example, the medium passage 41 may be horizontally formed such that the positions of the inlet 41a and the outlet 41b are the same in the direction of gravity Z.
The cover portion 53 may be formed of the same material as the second blade body 52. That is, the cover portion 53 may have the same ease of adhesion of adhesive as the second blade body 52. In addition, the cover portion 53 may be formed by coating a material to which adhesive tends not to adhere to.
The driven blade 39 may be configured without being provided with the cover portion 53. That is, the second blade body 52 and the tapered surface 39c may be integrally formed.
The medium P that is cut by the cutting device 22 is not limited only to paper, and various sheet-shape mediums such as cloth, metal foil, and plastic may be adopted.
The printing portion 21 that the printing apparatus 11 is provided with is not limited to the configuration in which printing is performed by discharging ink on the medium P. For example, there may be a configuration in which printing is performed using toner, and these various printing agents may be adopted.
The printing portion 21 that the printing apparatus 11 is provided with is not limited to a serial head type that performs printing on the medium P by moving back and forth in the width direction X. For example, there may be a line head type printing portion that is provided along the width direction X.
The transport unit 18 that transports the medium P is not limited to a roller, and may be a conveyor belt.

This application claims priority under 35 U.S.C. § 119 to Japanese Patent Application No. 2016-233917, filed Dec. 1, 2016. The entire disclosure of Japanese Patent Application No. 2016-233917 is hereby incorporated herein by reference.

What is claimed is:

1. A cutting device comprising:
a circular driving blade that drives to rotate;
a circular driven blade that is driven to rotate accompanying rotation of the driving blade; and
a holding portion that rotatably holds the driving blade and the driven blade in a state of cutting edges thereof being aligned with each other,
wherein a tapered surface that becomes tapered from the cutting edge side toward the revolving shaft side of the driven blade is formed on the contact surface on the side that contacts the driving blade in the driven blade.

2. The cutting device according to claim 1,
wherein the driven blade is formed with a cover portion, which has the tapered surface, installed on a blade body that has the cutting edge.

3. The cutting device according to claim 2,
wherein the cover portion is formed of a material that it is more difficult for adhesive to adhere to than the blade body.

4. The cutting device according to claim 1, further comprising:
a medium guiding portion that guides a medium which is cut at the cutting position at which the cutting edges of the driving blade and the driven blade are aligned with each other, and at which the medium is cut toward the revolving shaft side of the driven blade.

5. A printing apparatus comprising:
the cutting device according to claim 1;
a transport unit that transports a medium from an upstream side to a downstream side in a transport direction of the medium; and
a printing portion that prints on the medium.

6. A printing apparatus comprising:
the cutting device according to claim 2;
a transport unit that transports a medium from an upstream side to a downstream side in a transport direction of the medium; and
a printing portion that prints on the medium.

7. A printing apparatus comprising:
the cutting device according to claim 3;
a transport unit that transports a medium from an upstream side to a downstream side in a transport direction of the medium; and
a printing portion that prints on the medium.

8. A printing apparatus comprising:
the cutting device according to claim 4;
a transport unit that transports a medium from an upstream side to a downstream side in a transport direction of the medium; and
a printing portion that prints on the medium.
